(19) United States
(12) Patent Application Publication
(10) Pub. No.: US 2015/0269489 A1
(43) Pub. Date: Sep. 24, 2015

(54) SYSTEM AND METHOD FOR COMBINATORIAL OPTIMIZATION USING EVENT-DRIVEN, LAGRANGIAN BRANCH-AND-BOUND TECHNIQUES

(71) Applicant: New York University, New York, NY (US)

(72) Inventors: OLIVER BUHLER, New York, NY (US); Esteban G. Tabak, New York, NY (US); Giulio Trigila, Munich (DE)

(21) Appl. No.: 14/661,101

(22) Filed: Mar. 18, 2015

Related U.S. Application Data
(60) Provisional application No. 61/968,608, filed on Mar. 21, 2014.

(51) Int. Cl. G06N 5/04; G06N 7/00

(52) U.S. Cl. CPC G06N 5/04; G06N 7/00

(57) ABSTRACT

The present disclosure concerns a computer-implemented method for selecting an alternative, from a discrete set of alternatives, that is preferable with respect to one or more objectives, comprising: determining a Lagrangian function of the alternatives and one or more parameters; selecting an initial alternative from the set; determining values for the parameters; and selecting, via one or more iterations, an alternative from the set that reduces the Lagrangian subject to the determined parameter values. Further procedures can include determining at least two alternatives, wherein selecting a first alternative results in preference for a second alternative; dividing the set, including the first and second alternatives, into two disjoint subsets; maintaining branches for each subset while eliminating unfeasible branches; and selecting the alternative corresponding to a branch that reaches an optimal value or remains after eliminating all other branches. Other embodiments include devices and computer-readable media configurable to perform such procedures.

### CROSS-REFERENCE TO RELATED APPLICATION(S)

This application is based upon and claims the benefit of priority from U.S. Patent Application Ser. No. 61/968,608, filed on Mar. 21, 2014, the entire disclosure of which is incorporated herein by reference.

### FIELD OF THE DISCLOSURE

The present application relates to exemplary embodiments including methods, systems, devices, and computer-readable media for determining solutions to combinatorial optimization problems found in various applications in operations research and other fields (e.g., manufacturing, transportation, communications, etc.) using, e.g., event-driven, Lagrangian, branch-and-bound techniques.

### BACKGROUND INFORMATION

Combinatorial optimization seeks to minimize and objective or cost function ƒ(x) among a discrete set of alternatives, X, subject to further constraints. In some exemplary embodiments, X may comprise an operating space for a system or process, while in other exemplary embodiments X may comprise a design space for a system or process. A general formulation of the problem is given by:

$$f ( \hat{x} ) = {min}_{x ∈ X} f ( x ) , {g}^{i} ( x ) \geq 0 ∀ j ∈ [ 1 , {n}_{y} ] , {h}^{j} ( x ) = 0 ∀ j ∈ [ 1 , {n}_{z} ] , \qquad ( 1 )$$

where x takes values in an m-dimensional set X=X¹ [symbol] X² [symbol] . . . [symbol] X m such that xⁱεXⁱ holds for each component i=1, . . . , m, where Xⁱ has only a finite or countable set of elements. The functions g^{j}(x) provide a set of n_{y} inequality constraints, while the functions h^{j}(x) provide a set of n_{z} equality constraints. Although the size of set X is finite, it is typically large enough such that checking each xεX for feasibility (e.g., satisfaction of the ny+nz constraints) and exhaustively determining optimality would be prohibitively computationally expensive.

A combinatorial optimization under constraints can comprise a broad array of problems of practical significance, particularly in operations research. These issues can typically be difficult to solve (many are NP complete), both because of the exponentially large search space and of the difficulty of enforcing that the solution can only take on a discrete set of values.

Certain important algorithms are based on the linear formulation that many of these problems admit. In other words, functions ƒ(x), g^{j}(x) and h^{j}(x) are all linear functions of x:

$$f ( x ) = {\sum }_{i = 1}^{m} {f}_{i} {x}^{i} \cdot {g}^{j} ( x ) = {g}_{0}^{j} + {\sum }_{i = 1}^{m} {g}_{i}^{j} {x}^{i} \cdot {h}^{j} ( x ) = {h}_{0}^{j} + {\sum }_{i = 1}^{m} {h}_{i}^{j} {x}^{i} , \qquad ( 2 )$$

A subclass of combinatorial optimization that appears prominently in applications is “binary” programming, where each x^{j}εXⁱ={0, 1}. Widespread applications that can be formulated as binary programming problems include the “assignment,” “transportation” (also known as “generalized assignment”), and “traveling salesman” problems. A complementary subclass of combinatorial optimization problems is “integer” programming, where each xⁱ can take on any integer value in a countable infinite set, X. In each of these applications, a goal is to select a solution (e.g., a particular alternative) from among the discrete set of alternatives, X, that is preferable (e.g., optimal or near-optimal) in view of the constraints.

The examples mentioned above can be NP-complete, meaning that no algorithm has been found to solve them in a time that is of polynomial order in the size of the data. Most of the prior-art algorithms fall into one of three broad categories. One category comprises “exact” algorithms guaranteed to yield the correct result, but in some cases may consume computing resources that grow exponentially with the problem's size. Algorithms in this class may be computationally efficient and fast in particular problems, but in other problems their computational performance is poor. Second, there is a class of “approximate” algorithms guaranteed to converge in polynomial-order time to a solution or result that may—but is not guaranteed—to be close to optimal. Third, there is a class of “heuristic” algorithms that typically converge rapidly to a good solution, but cannot guarantee speed or quality.

Thus, it can be beneficial to address at least some of the issues and problems identified herein above.

### SUMMARY OF EXEMPLARY EMBODIMENTS

Accordingly, certain exemplary embodiments of methods, systems, devices, and computer-readable media of the present disclosure can provide benefits of both the first and second classes or categories. For example, the exemplary methods, systems, devices, and computer-readable media can yield—or determine that the problem does not have—an optimal solution in a computationally efficient manner. For example, exemplary embodiments of methods, systems, devices, and computer-readable media of the present disclosure can vastly out-perform conventional methods, techniques and systems in various known applications, including exemplary applications discussed herein.

Indeed, further exemplary embodiments of methods, systems, devices, and computer-readable media according to the present disclosure can provide these exemplary benefits through certain exemplary combination(s) and/or adaptation(s) of techniques from various fields including game theory, non-convex optimization, and computational modeling of processes with disparate time-scales. In this manner, the exemplary embodiments of methods, systems, devices, and computer-readable media according to the present disclosure can provide the following exemplary advantages over more traditional branch and bound methodologies:
Conceptual simplicity, due to the reformulation of the constrained optimization problem into a two-player game, one player employing a continuous strategy and the other employing a discrete strategy.
Broader applicability. Relaxing the restriction of the problem from being “linear” to be “additive” (e.g., “additive non-linear”) expands the universe of problems that can be solved.
Effectiveness. Certain “linear” problems can be solved more naturally and effectively by reformulation as “additive non-linear” problems, according to embodiments of the method disclosed herein.
Efficiency. Instead of solving a full LP program at each branch of the tree, embodiments of the present disclosure perform a few linear movements, greatly reducing the computational complexity compared to prior art techniques. Moreover, reformulating certain problems as “nonlinear” makes them more compact, thereby reducing exponentially the size of the space X to explore.
Versatility. Embodiments of the present disclosure support easy implementation on parallel computers, as well as swarming and initialization near a previously computed approximate solution.

In certain exemplary embodiments of the present disclosure, it is possible to provide a system, a computer-implemented method, and computer-accessible medium for selecting a particular alternative, from among a discrete set of alternatives, that is preferable with respect to one or more objectives. For example, with such method, it is possible to determine a Lagrangian function of the alternatives and at least one parameter; select an initial alternative from among the discrete set; determine values for the at least one parameter; and select, via one or more iterations, the particular alternative in the discrete set that reduces the Lagrangian function subject to the determined values for the at least one parameter. In some exemplary embodiments, the one or more objectives comprise an additive function of individual objectives; the Lagrangian function further comprises one or more constraints on the selection of a particular alternative; and each of the one or more constraints comprise one or more additive functions of individual constraints.

In certain exemplary embodiments, it is possible to determine at least two alternatives for which selection of a first of the at least two alternatives results in a preference for a second of the at least two alternatives; divide the discrete set into a plurality of disjoint sets of approximately equal size, including a first set comprising the first of the at least two alternatives and a second set comprising the second of the at least two alternatives; maintain solution branches for each of the plurality of sets during the one or more iterations, comprising eliminating solution branches that are determined to be unfeasible; and select the alternative corresponding to a solution branch that reaches an optimal value or to a solution branch that remains after all other solution branches have been eliminated.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments, in which:

FIG. 1 is a block diagram of an exemplary control device and/or apparatus according to one or more exemplary embodiments of the present disclosure;

FIG. 2 is a flow diagram of an exemplary Lagrangian optimization method according to one or more exemplary embodiments of the present disclosure; and

FIG. 3 is a flow diagram of another exemplary Lagrangian optimization method according to one or more exemplary embodiments of the present disclosure.

While the present disclosure will now be described in detail with reference to the figures, it is done so in connection with the illustrative embodiments and is not limited by the particular embodiments illustrated in the figure(s) or in the appended claims.

### DETAILED DESCRIPTION OF EXEMPLARY EMBODIMENTS

As indicated herein, the exemplary embodiments of methods, systems, devices, and computer-readable media according to the present disclosure can be based on the recognition and/or understanding that the functions ƒ(x), g^{j}(x) and h^{j}(x) can be constrained to be “additive” rather than “linear” as in prior art methods. In this formulation, ƒ(x), g^{j}(x) and h^{j}(x) can be expressed as:

$$f ( x ) = {\sum }_{i = 1}^{m} {f}_{i} ( {x}^{i} ) , {g}^{j} ( x ) = {g}_{0}^{j} + {\sum }_{i = 1}^{m`} {g}_{i}^{j} ( {x}^{i} ) , {h}^{j} ( x ) = {h}_{0}^{j} + {\sum }_{i = 1}^{m} {h}_{i}^{j} ( {x}^{i} ) . \qquad ( 3 )$$

Within this exemplary formulation, all the functions ƒ(x), g^{j}(x) and h^{j}(x) can be allowed to be fully nonlinear, e.g., they can be defined point-wise by assigning unrestricted values at each x^{j}εXⁱ. As discussed herein, the exemplary reformulation of ƒ(x), g^{j}(x) and h^{j}(x) into the less restrictive “additive” format can provide large improvements in the computational complexity, even for problems that also admit a linear formulation. Moreover, allowing ƒ(x), g^{j}(x) and h^{j}(x) to be non-linear (e.g., sum of non-linear functions) can extend the range of problems that can be solved.

Furthermore, according to certain exemplary embodiments of the present disclosure, system, computer-implemented method, and computer-readable medium can be provided for solving such non-linear formulations of the constrained optimization problems. Such exemplary system, computer-implemented method, and computer-readable medium can formulate the combinatorial optimization problem of equation (1), where functions ƒ(x), g^{j}(x) and h^{j}(x) are allowed to be additive nonlinear as in equation (3), using the following unconstrained Lagrangian function:

$$L ( x , y , z ) = f ( x ) - {\sum }_{j = 1}^{n} {y}^{j} {g}^{j} ( x ) = f ( x ) - {y}^{′} g ( x ) - {z}^{′} h ( x ) . \qquad ( 4 )$$

Based on this Lagrangian formulation, the optimization problem in equation (1) can be formulated as a dynamical mini-max game, e.g.:

$$f ( \hat{x} ) = {min}_{x ∈ X} {max}_{y ∈ Y , z ∈ Z} L ( x , y , z ) , \qquad ( 5 )$$

where Y=R^{+ny}(i.e., real, positive-valued n_{y}-dimensional vectors) and Z=R^{nz} (i.e., real n_{z}-dimensional vectors). One way to describe this formulation is to define x as the discrete-valued strategy of a first player that, as the result of the game, will incur a cost L(x, y, z). This first player would like to minimize his or her losses under the worst possible scenario, which corresponds to the maximization of cost L over the range of possible scenarios, represented by parameters that correspond to the strategy of the second player in the game, such as continuous-valued variables y and z.

According to another exemplary embodiments of the present disclosure, dynamic, event-driven system, method and computer-readable medium can be provided for determining the optimal solution of the Lagrangian formulation of the constrained optimization problem given by equation (5). The Lagrange multipliers [y, z] perform a dynamic maximization of L through gradient ascent under the current values of x. Since x can only take on a discrete set of values, the solution method “jumps” instantly to a value from the discrete set x that minimize L under the current values of [y, z]. In terms of a game paradigm, the first player's goal can be achieved if the constraints are satisfied and the optimal solution is determined. Otherwise, if the goal is not achieved, then it is determined that no feasible solution exists. In terms of the “game” paradigm, this novel method efficiently evolves this game toward its conclusion.

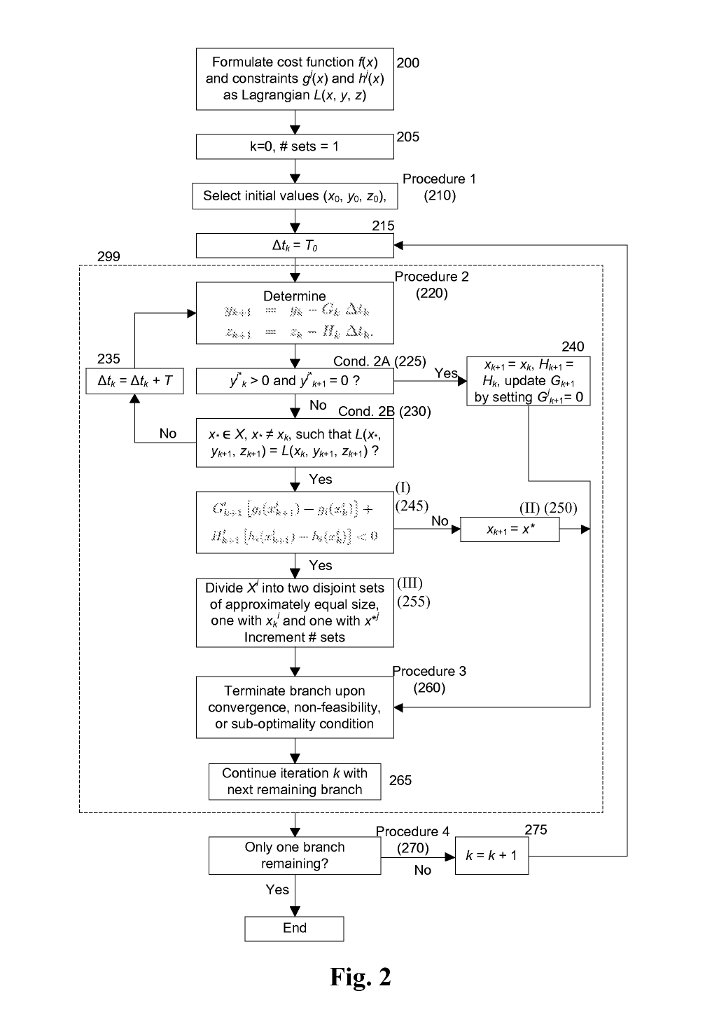

Exemplary procedures used by the exemplary system, method, and computer-readable medium according to the present disclosure may include and/or utilize the procedures described as follows, which corresponds to the flow diagram shown FIG. 2. Although the exemplary method is illustrated in FIG. 2 by blocks in the particular order shown in FIG. 2, this order is merely exemplary, and the functions corresponding to the blocks may be performed in different orders and can be combined and/or divided into blocks having different functionality than shown in FIG. 2. Each of the blocks shown in FIG. 2 are designated numerically (e.g., “200”); however, certain ones of the blocks also include a designation corresponding to a portion of the procedure (e.g., “Procedure 1”).

Turning to FIG. 2, initially, the exemplary procedure proceeds to block 200, where cost function ƒ(x) and constraints g^{j}(x) and h^{j}(x) are formulated as a Lagrangian L(x, y, z), as described herein above. In block 205, the iteration counter, k, is initialized to zero and the number of sets is initialized to one, signifying that no branching or division into subsets has taken place. In block 210, the procedure designated as “Procedure 1” below is performed.

Procedure 1. Initialize by selecting:

$${y}_{0} ∈ Y , {z}_{0} ∈ Z arbitrary \\ {x}_{0} = {argmin}_{x ∈ X} L ( x , {y}_{0} , {z}_{0} ) , \qquad ( 6 )$$

where the expression for x₀, the initial value, indicates the value of xεX that produces the minimum L for initial values y₀ and z₀. In block 215, the time increment Δtₖ is initialized as T₀, the minimum time for which an event takes place. In FIG. 2, block 299 encompasses procedures that are performed each iteration for all branches. The first of these procedures is block 220, in which the procedure designated as “Procedure 2” below is performed:

Procedure 2. Beginning from initial values (x₀, y₀, z₀), determine values (xₖ₊₁, Yₖ₊₁, zₖ₊₁) for next iteration k+1 based on values (xₖ, yₖ, zₖ) for current iteration k according to gradient ascent in (y, z)-space, which takes on the form:

yₖ₊₁=yₖ−GₖΔtₖ

zₖ₊₁=zₖ−HₖΔtₖ. (7)

where iteration index k enumerates the events that occur along the search, H^{j}ₖ=h^{j}(xₖ), and

$${G}_{k}^{j} = \{ \begin{matrix}{g}^{j} ( {x}_{k} ) & if {y}_{k}^{j} > 0 \\ min ( {g}^{j} ( {x}_{k} ) , 0 ) & if {y}_{k}^{j} = 0\end{matrix} . \qquad ( 8 )$$

As indicated in equations (7) and (8), under constant x, the evolution of [y, z] is linear in time, and can therefore be performed in a single time-step, Δt., as indicated herein with reference to block 215. The length of this procedure can be determined by the minimal time after which either a currently positive entry of y reaches zero, or one entry of x is led to jump to a different value. Such exemplary “event-driven” procedure utilized by the exemplary system, method and computer-readable medium according to certain exemplary embodiments of the present disclosure can be applied to various applications involving simple, exactly-solvable dynamics punctuated by more complex but effectively instantaneous phenomena. One example from the field of physics can be freely moving particles punctuated by collisions.

More specifically, an exemplary determination of Δtₖ as the minimum time interval until one of the following two conditions can occur, as determined in blocks 225 and 230, respectively:

Condition 2A. There is some j* such that y^{j*}ₖ>0 and y^{j*}ₖ₊₁=0. In response to this exemplary condition, set xₖ₊₁=xₖ, Hₖ₊₁=Hₖ, update Gₖ₊₁ by setting G^{j}ₖ₊₁=0 (block 240), and continue to Procedure 3 (block 260) described below.
Condition 2B. Otherwise, is there is some x*εX, x*≠xₖ, such that L(x*, yₖ₊₁, zₖ₊₁)=L(xₖ, yₖ₊₁, zₖ₊₁). This condition is a manifestation of the problem's non-convexity such that two values of x arise, such that under each the evolution of [y, z] leads to immediately prefer the other. If exemplary Condition 2B is not satisfied, the procedure continues to block 235 where Δtₖ is incremented and further to block 220 to begin the next iteration.

In response to satisfaction of exemplary Condition 2B, the exemplary system, method and computer-readable medium embodiments can select between xₖ₊₁=x* and xₖ₊₁=xₖ, both of which can minimize L at the current location in [y, z]-space, by utilizing a novel branch-and-bound technique. Unlike conventional solutions, such exemplary system, method and computer-readable medium embodiments do not require solving LP problems along each branch and are not restricted to linear problems. Further, unlike conventional solutions that use branching to progressively enforce the required discrete nature of the solution, such exemplary system, method and computer-readable medium according to certain exemplary embodiments of the present disclosure can only consider discrete solutions throughout the solution process (i.e., the “game”), with branching used to discriminate between disjoint subsets of the search space. This can lead to a much more effective search even for problems that admit a linear formulation.

Conceptually, the boundary between the two regions in [y, z] space where either xₖ or x* yield a smaller value of L satisfies L(x*, y, z)=L(xₖ, y, z) and includes [yₖ₊₁, zₖ₊₁]. Since L is affinely dependent on y and z, this boundary is conceptually a plane hyper-surface in [y, z]-space. As shown in equation (7), the gradient ascent search for xₖ arrived at this boundary, which is therefore an exit boundary for xₖ. If the search continued in the current search direction, it would cross the boundary, and likely make xₖ sub-optimal.

On the other hand, switching to the updated search direction based on x*may either (1) lead away from the boundary or (2) cross back into the region where the previous xₖ was optimal. In the first case, the boundary is an entry boundary for the region where x* is optimal, resulting in choosing xₖ₊₁=x* to continue the gradient ascent along the new search direction based on this value of x. In the second case, the boundary is an exit boundary for the gradient ascent for both xₖ and x*, so neither can be chosen without arbitrarily excluding the other. This second case occurs when, e.g.:

$${\frac{d}{d t} [ \begin{matrix}L ( {x}_{k + 1} , {y}_{k + 1} - {G}_{k + 1} t , {z}_{k + 1} - {H}_{k + 1} t ) - \\ L ( {x}_{k} , {y}_{k + 1} - {G}_{k + 1} t , {z}_{k + 1} - {H}_{k + 1} t )\end{matrix} ]}_{t = 0} < 0 \qquad ( 9 a )$$

which due to the additivity property of L reduces to

G′ₖ₊₁[gᵢ(xₖ₊₁ⁱ)−gᵢ(xₖⁱ)]+H′ₖ₊₁[hᵢ(xₖ₊₁ⁱ)−hᵢ(xₖⁱ)]<0, (9b)

where i the component where xₖ₊₁ and x* differ. Accordingly, various systems, methods and computer-readable medium according to exemplary embodiments of the present disclosure can utilize the following branching technique with respect to Condition 2B (block 230):
I. Determine whether the inequality of equation (9b) is true or false (block 245).
II. If the inequality of (9b) is false, then set xₖ₊₁=x* (block 250) and continue to Procedure 3 (block 260) described below. The value x=x* will continue to be optimal under the evolution of θ and z in future iterations.
III. If the inequality of (9b) is true, branch by dividing Xⁱ into two disjoint sets of approximately equal size, one containing xₖⁱ and the other containing x*ⁱ. (block 255). The alternative x-value has now become unavailable in each branch and therefore each branch contains an unambiguous optimal xₖ₊₁ with which to continue the search in [y, z]-space. Continue to Procedure 3 (block 260).

Procedure 3. If branches have been made, maintain consistency between branches by monitoring L within each branch and terminating demonstrably suboptimal branches. For example, the exemplary technique utilized by the exemplary system, method and computer-readable medium can terminate a particular branch when one of the following events occurs:
A. Gₖ=Hₖ=0, which occurs when the method has converged to the optimal solution xₖ within the particular branch;
B. Δtₖ=∞, which occurs when the current branch is unfeasible, since L grows arbitrarily large; or
C. The current branch is necessarily suboptimal, which occurs when L surpasses its value for the best feasible solution found so far, or its upper bound for feasible solutions given by

$${L}_{max} = {max}_{x ∈ X} f ( x ) . \qquad ( 10 )$$

Once a branch ends, continue iterations with the open branch having the smallest value of L (block 265).

Procedure 4. If there are open branches remaining (block 270), repeat steps 2-3 (e.g., procedures within block 299) after incrementing iteration counter k block 275). When there are no open branches remaining (block 270), the method ends. When the set X is finite, the method converges in a finite number of steps to the problem's optimal solution, or ends without finding any feasible solution when there is none.

As discussed above with reference to equation (6), the exemplary technique(s) or procedure(s) utilized by the exemplary system, method and computer-readable medium can be initialized with arbitrary initial values y₀ and z₀ together with the value of x₀εX that produces the minimum L for initial values y₀ and z₀. Because the exemplary technique(s) can start from arbitrary initial values of [y; z] the exemplary system, method and computer-readable medium to utilize the concept of “swarming” including performing various runs with different initial [y, z] values in parallel, communicating only through the current optimal value of L among feasible solutions.

In other exemplary embodiments of system, method and computer-readable medium of the present disclosure, the computing time and storage requirement of the branch-and-bound technique utilized with respect to Condition 2B described above can be reduced by reducing the number of branches explored. In such exemplary embodiments, rather than branching, the exemplary system, method and computer-readable medium can select the search directions G and H in [y, z]-space so that the current optimal solutions x₁, x₂, etc. can co-exist as optimal solutions under the evolution of y and z. Such procedure(s)/technique(s) utilized by the exemplary system, method and computer-readable medium can proceed as in the previously-described embodiments until reaching a branching point, where:

G′₂[gᵢ(x₂ⁱ)−gᵢ(x₁ⁱ)]+H′₂[hᵢ(x₂ⁱ)−hᵢ(x₁ⁱ)]≧0. (11)

where x₂ is the new value of x, x₁ is the previous value of x, Hₖ=h(xₖ) and

$${G}_{k}^{j} = \{ \begin{matrix}{g}^{j} ( {x}_{k} ) & if {y}^{j} > 0 \\ min ( {g}^{j} ( {x}_{k} ) , 0 ) & if {y}^{j} = 0\end{matrix} . \qquad ( 12 )$$

As discussed herein, an exemplary motivation for branching under Condition 2B above can be that choosing x₂ immediately leads to a preference for another x*≠x₂, while choosing x* immediately leads to a preference for x₂. Nevertheless, although following a gradient flow is a natural approach, it is not necessary to select between the two directions. Rather, the growth rate dL/dt of the Lagrangian L needs only to be positive, not necessarily maximal. Accordingly, the exemplary system, method and computer-readable medium of these alternative exemplary embodiments can select x₂ and vectors G and H, where

$$\frac{d y}{d t} = - G , \frac{d z}{d t} = - H , \qquad ( 13 )$$

and G and H must satisfy the following criteria:
C1. G′g(x₂)+H′h(x₂)>0 (i.e., L is growing);
C2. G′g(x₁)+H′h(x₁)>G′g(x₂)+H′h(x₂) (i.e., not forced to switch immediately back to x=x₁);
C3. Gⱼ≦0 for all indices j such that yⱼ=0 (i.e., y remains nonnegative).

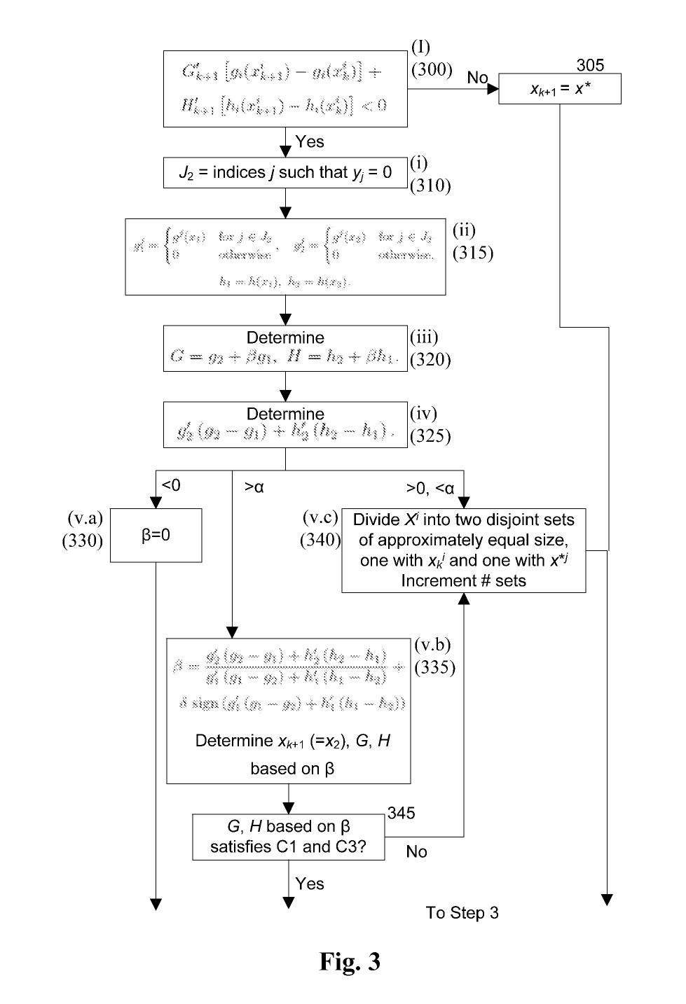

Further, exemplary system, method and computer-readable medium can determine vectors G and H in various manners. One exemplary procedure/technique utilized by the exemplary system, method and computer-readable medium is described as follows, and corresponds to the flow diagram shown in FIG. 3. Although the exemplary method is illustrated in FIG. 3 by blocks in the particular order shown in FIG. 2, this order is merely exemplary, and the functions corresponding to the blocks may be performed in different orders and can be combined and/or divided into blocks having different functionality than shown in FIG. 3. Each of the blocks shown in FIG. 3 are designated numerically (e.g., “300”); however, certain ones of the blocks also include a designation corresponding to a portion of the procedure (e.g., “(I)”).

Turning to FIG. 3, initially the exemplary procedure proceeds to block 300, where it is determined whether the inequality of equation (9b) is true or false. If the inequality of (9b) is false, then set xₖ₊₁=x*(block 305) and continue to Procedure 3 (e.g., block 260 in FIG. 2). Otherwise, if the inequality of (9b) is true, then perform the following procedures:
i. Denote J₂ as the set of indices j that are “active” for x₂ such that either yⱼ>0 or yⱼ=0, and gⱼ(x₂)<0 (block 310).
ii. Introduce the two pairs of vectors [g₁; h₁] and [g₂; h₂] (block 315), such that

$${g}_{1}^{j} = \{ \begin{matrix}{g}^{j} ( {x}_{1} ) & for j ∈ {J}_{2} \\ 0 & otherwise\end{matrix} , {g}_{2}^{j} = \{ \begin{matrix}{g}^{j} ( {x}_{2} ) & for j ∈ {J}_{2} \\ 0 & otherwise\end{matrix} , \\ {h}_{1} = h ( {x}_{1} ) , {h}_{2} = h ( {x}_{2} ) . \qquad ( 14 )$$

iii. Determine G and H based on [g₁; h₁], [g₂; h₂], and additional variable β (block 320):

G=g₂+βg₁,H=h₂+βh₁. (15)
iv. Reformulate criterion C2 above as (block 325):

[g′₁(g₁−g₂)+h′₁(h₁−h₂)]β>g′₂(g₂−g₁)+h′₂(h₂−h₁). (16)
v. Based on the value of the right-hand side of equation (16), take a particular action for each of the following three scenarios:
   a. If g′₂(g₂−g₁)+h′₂(h₂−h₁)<0, then choose β=0 and do not branch (block 330, which corresponds to the non-branching scenario in the embodiments described above);
   b. If g′₂(g₂−g₁)+h′₂(h₂−h₁)>α (where α is a threshold value >0), then select β according to (17) below (block 335).

$$β = \frac{{g}_{2}^{′} ( {g}_{2} - {g}_{1} ) + {h}_{2}^{′} ( {h}_{2} - {h}_{1} )}{{g}_{1}^{′} ( {g}_{1} - {g}_{2} ) + {h}_{1}^{′} ( {h}_{1} - {h}_{2} )} + δ sign ( {g}_{1}^{′} ( {g}_{1} - {g}_{2} ) + {h}_{1}^{′} ( {h}_{1} - {h}_{2} ) ) , \qquad ( 17 )$$

If G and H computed by procedure (15) using the selected β satisfy exemplary criteria C1 and C3 above (block 345), then do not branch.
If G and H do not satisfy both criteria C1 and C3, then branch (block 340) and continue to, e.g., Procedure 3 (block 260) in FIG. 2.
c. Otherwise, if 0≦g′₂(g₂−g₁)+h′₂(h₂−h₁)≦α, then branch (block 340) and continue to, e.g., Procedure 3 (block 260) in FIG. 2.

In addition, the exemplary technique/procedure can also branch if Δt=0, which otherwise may cause the solution to alternate between three or more values of x.

The person of ordinary skill will also realize that other variations of the exemplary system, method and computer-readable medium are also possible. For example, in some exemplary embodiments, G and H may be chosen so that x₁ and x₂ can co-exist as optimal solutions. If a third candidate x₃ arises, and there is no consistent way to select a “winner”, find a direction [G, H] such that the three can co-exist, e.g., L(x₁, y, z)=L(x₂, y, z)=L(x₃, y, z). This can be continued until either a winner is identified or no consistent [G, H] can be found, which causes the method to branch as discussed above. More generally, the exemplary system, method and computer-readable medium can be used to accumulate up to n−1 competing values of x before becoming unable to ascend further in the gradient and being forced to branch.

As discussed above, various embodiments of the exemplary system, method and computer-readable medium can utilize the procedure(s)/techniques(s) that can be initialized with arbitrary initial values y₀ and z₀ together with the value of x₀εX that produces the minimum L for initial values y₀ and z₀. According to other exemplary embodiments, the method can be initialized by specify the initial x=x₀, then determining values for [y₀, z₀] that satisfies equation (6). In some embodiments, this can be performed by setting

y₀^{j}=Y₀(g^{j}(x₀)),z₀^{j}=0. (18)

where Y₀(w) is a non-decreasing function of w satisfying

$${Y}_{0} ( ω ) = {Y}_{max} ≫ 1 for ω > 0 , \\ {lim}_{w \to - ∞} {Y}_{0} ( w ) = 0. \qquad ( 19 )$$

For example, Y₀(w) can be selected as

$${Y}_{0} ( w ) = \{ \begin{matrix}{Y}_{max} & for w > 0 , \\ \frac{{Y}_{tol}}{1 - w} & for w \leq 0 ,\end{matrix} , 0 \leq {Y}_{tol} \leq {Y}_{max} . \qquad ( 20 )$$

For example, it may be beneficial to force the initial x to satisfy the same constraints that x₀ satisfies by penalizing heavily their non-satisfaction, while making the penalty very light or non-existent (Yₜₒₗ=0 in the Y₀ above) for those constraints that x₀ does not satisfy. The person of ordinary skill can readily comprehend that these procedures can be merely exemplary and much more sophisticated procedures can be developed if required. For example, x₀ does not need to belong to X for the initialization routine just described, provided that the functions gᵢ can be extended so that they can be evaluated at x₀. It is possible to take advantage, for instance, of a non-integer solution to an integer programming problem.

Moreover, the person of ordinary skill can readily comprehend that the various embodiments of the exemplary system, method and computer-readable medium according to the present disclosure described herein can be equally applicable to the situation where one or more of the constraints of equations (1) and (8) are equalities rather than inequalities. The only exemplary difference is that the corresponding Lagrange multipliers y₁ are no longer required to be positive, and so the corresponding G^{j}ₖ are given by

Gₖ^{j}=g^{j}(xₖ). (21)

Various embodiments of the exemplary system, method and computer-readable medium according to the present disclosure described herein can be used in a variety of applications. Persons of ordinary skill will recognize that combinatorial optimization can be utilized in various ways in such applications to determine a particular alternative from among a set of alternatives. In some exemplary embodiments, the set of alternatives can comprise the operating space of a system or process and/or the design space of a system or process. For example, many of classical problems of combinatorial optimization in operations research and other fields can be formulated as linear programming problems using the Lagrangian, given by:

ƒ(x)=c′x,cε [symbol] ^{m},

g(x)=Ax−b,Aε [symbol] ^{n×m},bε [symbol] ⁿ

L(x,y)=c′x+b′y−y′Ax (22)

where b is a real-valued, n-dimensional vector, c is a real-valued, m-dimensional vector, and A is a real-valued, n-by-m-dimensional matrix. Vectors b and c and matrix A may be normalized or scaled pre-solution so long as this is taken into account post-solution. To emphasize the dependence of the Lagrangian on x or y, it is convenient to rewrite it in the two alternate forms:

L(x,y)=−(A′y−c)′x+b′y=−(Ax−b)′y+c′x (23)

Accordingly, the constraints can be expressed as

$${g}_{k}^{j} = \{ \begin{matrix}{A}_{j} x - {b}_{j} & for {y}_{k}^{j} > 0 and for equality contraints \\ min ( {A}_{j} x - {b}_{j} , 0 ) & \begin{matrix}for {y}_{k}^{j} = 0 , \\ {j}^{′} s corresponding to inequality contraints\end{matrix}\end{matrix} \qquad ( 24 )$$

Based on this formulation, various embodiments of the exemplary system, method and computer-readable medium according to the present disclosure described herein can be used to solve a variety of linear programming problems.

In addition, the exemplary system, method and computer-readable medium according to the present disclosure described herein can be utilized to solve a variety of binary programming problems that commonly appear in operations research and other fields. In binary programming, X is the subset of R^{m}(i.e., real-valued, m-dimensional vectors) where all entries of the vectors xεX are either zero or one. All binary problems with additive f, g and h are linear, since a function with only two possible values as domain can always be extended to the line that interpolates between the two. Using the Lagrangian formulation and considering only inequality constraints, for a given y, the x minimizing L is given by

$${x}^{i} = \{ \begin{matrix}1 & if {( {A}^{′} y - c )}_{i} > 0 \\ 0 & if {( {A}^{′} y - c )}_{i} < 0\end{matrix} , \qquad ( 25 )$$

where the undefined case when (A′y−c)ᵢ=0 is handled separately, since it occurs only in between steps and at branching points. Embodiments may compute Δtₖ by monitoring the sign of the components of A′(yₖ−gₖt)−c, resulting in

$$Δ {t}_{k} = min \{ \begin{matrix}{min}_{i} {[ \frac{{y}_{k}^{j} {A}^{′} - {c}_{j}}{{g}_{k}^{j} {A}^{′}} ]}^{+} \\ {min}_{j} {[ \frac{{y}_{k}^{j}}{{g}_{k}^{j}} ]}^{+}\end{matrix} , \qquad ( 26 )$$

The exemplary system, method and computer-readable medium according to the present disclosure can also be used to solve the “knapsack problem” that is a particular case of binary programming having the single constraint

$${\sum }_{j} {w}_{j} , {r}_{j} \leq W . \qquad ( 27 )$$

subject to the maximization:

$${max}_{x} {v}^{′} x , {x}_{j} ∈ \{ 0 , 1 \} . \qquad ( 28 )$$

The exemplary systems, methods and computer-readable medium described herein for the general binary programming problem can be applied to the knapsack variant by using a single Lagrange multiplier y. Other exemplary formulations of the constraints using “ghost” variables may be used; these may result in fewer branches depending on the particular problem or application.

In addition, the exemplary system, method and computer-readable medium according to the present disclosure described herein can be utilized to solve a variety problems that commonly appear in operations research and other fields, which can be formulated as the so-called “generalized assignment problem” (GAP). This problem involves finding a maximum profit assignment from q tasks to n machines or persons (“agents”) such that each task is assigned to precisely one agent subject to capacity restrictions on the agents. Task i has size relative to the agent j, who has the capacity to perform more than one task, provided that the task sizes do not add up to more than the agent's budget bⱼ. Agent j bids a price c^{j}ᵢ to perform task j, and each agent may choose not to bid for some tasks that, depending on the problem's formulation, causes the corresponding price c^{j}ᵢ to be set to infinity or simply not considered at all. The goal can be to find a solution (e.g., a particular alternative) where all tasks are performed with the total cost of the operation being minimized.

Using the Lagrangian formulation of according to exemplary system, method and computer-readable medium of the exemplary embodiments of the present disclosure described herein, the GAP can be reformulated into a more compact and effective, non-linear formulation similar to (1):

$${min}_{x ∈ X} f ( x ) , {g}^{j} ( x ) \geq 0 , j = 1 , … , n . \qquad ( 29 )$$

In this formulation, X is a q-dimensional set, with one component xᵢ per task, with a value the index j of the company that will perform it, such that:

$$f ( x ) = {\sum }_{i} {f}_{i} ( {x}^{i} ) , {f}_{i} ( z ) = {\sum }_{j} {c}_{i}^{j} {δ}_{z}^{j} \\ {g}^{j} ( x ) = {b}_{j} - {\sum }_{i} {s}_{i}^{j} {δ}_{s}^{{x}^{′}} . \qquad ( 30 )$$

In the above, δ^{j}ᵢ is the Kronecker delta function, which is one when i=j and zero otherwise. Using embodiments of the method described herein, the value of Δtₖ can be calculated based on:

$$Δ {t}_{k} = min \{ \begin{matrix}{min}_{i} \{ {min}_{x ∈ {X}^{i} , x \neq {x}_{k}^{i}} {[ \frac{[ {c}_{i}^{x} + {y}_{k}^{x} {s}_{i}^{x} ] - [ {c}_{i}^{{x}_{k}^{i}} + {y}_{k}^{{x}^{i}} {s}_{i}^{{w}_{k}^{i}} ]}{{G}_{k}^{x} {s}_{i}^{x} - {G}_{k}^{{x}^{i}} {s}_{i}^{{x}^{i}}} ]}^{+} \} \\ {min}_{j} {[ \frac{{y}_{k}^{i}}{{G}_{k}^{j}} ]}^{+}\end{matrix} \qquad ( 31 )$$

Additionally, the non-branching condition can be determined as

$${G}_{k + 1}^{{x}_{k + 1}^{i}} {s}_{i}^{{x}_{k + 1}^{i}} - {G}_{k + 1}^{{x}_{k}^{i}} {s}_{i}^{{x}_{k}^{i}} < 0 , \qquad ( 32 )$$

where i is the component by which xₖ and xₖ₊₁ differ. Since each of the q tasks can be performed by only one of the n agents, this formulation results in a total of n^{q} possibilities. In the traditional formulation, there are n-times-q binary variables which results in an exponentially larger search space of 2^{nq} possibilities.

In addition, exemplary system, method and computer-readable medium according to the exemplary embodiments of the present disclosure described herein can be utilized to solve a variety problems that commonly appear in operations research and other fields, which can be formulated as the so-called “assignment” or “transportation” problem. By way of example, a taxi company has three taxis (“agents”) available, and three customers needing to be picked up as soon as possible (“tasks”). The company wants to provide speedy service, so for each taxi the “cost” of picking up a particular customer will depend on the time taken for the taxi to reach the pickup point. For this application, the solution to the assignment problem will provide the combination of taxis and customers (e.g., the particular alternative) that results in the least total cost. Variations including a number of taxis greater than or less than the number of customers, multiple customers per taxi, etc. are also possible. The person of ordinary skill can recognize that many other applications involving minimizing cost over multiple agents and multiple tasks are amenable to solution by the exemplary system, method and computer-readable medium according to the exemplary embodiments of the present disclosure described herein including assigning fleets of aircraft to particular trips, assigning school buses to particular routes, networking of computers, etc.

In the transportation problem, the unknown is the array of binary variables πᵢⱼ, i=1 . . . n; j=1 . . . n, where πᵢⱼ equals one for exactly one i per j and one j per i, and the goal is to minimize the total transportation cost

$${\sum }_{i , j} {c}_{ij} {π}_{ij} \qquad ( 33 )$$

subject to the constraints

$${\sum }_{i} {π}_{ij} = {\sum }_{j} {π}_{ij} = 1. \qquad ( 34 )$$

To utilize the Lagrangian formulation of the exemplary system, method and computer-readable medium according to the exemplary embodiments of the present disclosure described herein above, the method introduces an n-dimensional vector x, where each component xᵢ takes on values in (1 . . . n), such that the problem is reformulated as

$$\begin{matrix}{min}_{x ∈ {[ 1 : n ]}^{n}} f ( x ) , {g}^{j} ( x ) = 0 , j = 1 , … , n , & ( 35 a ) \\ f ( x ) = {\sum }_{i} {f}_{i} ( {x}^{i} ) , {f}_{i} ( x ) = {\sum }_{j} {c}_{i}^{j} {δ}_{x}^{j} \\ {g}^{j} ( x ) = 1 - {\sum }_{i} {δ}_{j}^{{x}^{′}} . & ( 35 b )\end{matrix}$$

Using the exemplary system, method and computer-readable medium according to the exemplary embodiments of the present disclosure he exemplary system, method and computer-readable medium according to the exemplary embodiments of the present disclosure described herein, the value of Δtₖ can be calculated based on:

$$Δ {t}_{k} = {min}_{i} \{ {min}_{w ∈ [ 1 : n ] , w \neq {x}_{k}^{′}} {[ \frac{[ {c}_{i}^{w} + {y}_{k}^{w} ] - [ {c}_{i}^{{x}_{k}^{′}} + {y}_{k}^{{x}^{′}} ]}{{G}_{k}^{w} - {G}_{k}^{{x}^{′}}} ]}^{+} \} \qquad ( 36 )$$

In addition, the exemplary system, method and computer-readable medium according to the exemplary embodiments of the present disclosure described herein can be utilized to solve a variety problems that commonly appear in operations research and other fields, which can be formulated as the so-called “travelling salesman problem” (TSP). Numerous concrete and practical applications of the TSP are described in U.S. Pat. No. 7,054,798, Punch and Die Optimization, and R. Matai, et al., Travelling Salesman Problem: An Overview of Applications, Formulations, and Solution Approaches, (ch. 1 of Travelling Salesman Problem: Theory and Applications, ed. D. Davendra, Dec. 30, 2010). Both of these sources are incorporated herein by reference. Such concrete and practical applications can include placement of turbine blades when servicing gas turbine engines, positioning an x-ray diffractometer for making repetitive measurements of a crystalline structure, routing of wiring traces on a printed circuit board, finding the shortest path for picking up items of an order in a warehouse, routing of fleets of vehicles, scheduling output of printing presses or steel mills, etc. Problems found in these and other exemplary concrete and practical applications can be formulated by the TSP framework described below, and solved using exemplary embodiments described herein.

In the TSP, there are n+1 “cities” to visit on a “tour.” The goal is to select a tour that starts in one city, goes through all the others (visiting each only once) and returns to the first one, minimizing a cost such as the sum of the distances traveled. Let c^{j}ᵢ be the cost to travel from city i to city j. The problem is typically formulated as finding a permutation x of [0 . . . n] that minimizes the total cost

$$C = {\sum }_{i = 0}^{n} {c}_{{x}^{i}}^{{x}^{i + 1}} , \qquad ( 37 )$$

where xⁱ⁺¹=x₀, subject to the permutation constraints expressed as

$${\sum }_{i} {δ}_{j}^{{x}^{i}} = 1 , j = 0 … n . \qquad ( 38 )$$

For example, the cost C above is not additive over the x₁, but instead over pairs {xᵢ, xᵢ₊₁}. According to embodiments of the present disclosure, the traveling salesman problem can be reformulated as an integer linear problem, by introducing binary variables π^{j}ᵢ, which are equal to one if one of the segments of the path goes from city i to city j, and to zero otherwise. Since every city must be visited once, the constraints and cost function, respectively, are:

$$\begin{matrix}{\sum }_{i = 0}^{n} {π}_{i}^{j} = 1 , {\sum }_{j = 0}^{n} {π}_{i}^{j} = 1. & ( 39 a ) \\ C = {\sum }_{i , j} {c}_{i}^{j} {π}_{i}^{j} & ( 39 b )\end{matrix}$$

This exemplary formulation can be solved using embodiments described herein above. To avoid loops that do not go through all the cities, auxiliary variables uᵢ, i=1 . . . n, uᵢε[1 . . . n] (i=0 excluded) may be introduced, resulting in constraints

uᵢ−uⱼ+nπᵢ^{j}≦n−1,i,jε[1 . . . n]. (40)

If there were any loop not including city i=0, adding the inequalities in (40) over the segments of the loop yields the contradiction n<n−1, showing that all loops must include i=0 and thus there is a single loop. For any such loop spanning all cities, the inequalities in (40) are satisfied by choosing uᵢ as the order of city i in the loop.

Alternately or in addition, the TSP can be reformulated to more effectively utilize the advantageous of embodiments described herein, by retaining the variables uᵢ but replacing the (n+1)² binary variables π^{j}ᵢ with n+1 variables dᵢε[0 . . . n]−i specifying the city that is the destination after city i. The condition that all cities must be visited once becomes n+1 constraints

$${\sum }_{i} {δ}_{{d}_{i}}^{j} = 1 , j = 0 … n . \qquad ( 41 )$$

In some exemplary embodiments, the constraints of (41) can be expressed as inequalities rather than equalities. Furthermore, the constraints of (40) and cost function of (39b), respectively, can be reformulated in terms of d as:

$$\begin{matrix}{u}_{i} - {u}_{j} + n {δ}_{{d}_{i}}^{j} \leq n - 1 , i , j ∈ [ 1 … n ] , & ( 42 a ) \\ C = {\sum }_{i , j} {c}_{i}^{j} {δ}_{{d}_{i}}^{j} . & ( 42 b )\end{matrix}$$

The cost function (42a) and constraints (42b) are additive over the variables uᵢ and dᵢ, which is a condition for the using embodiments of the method described herein.

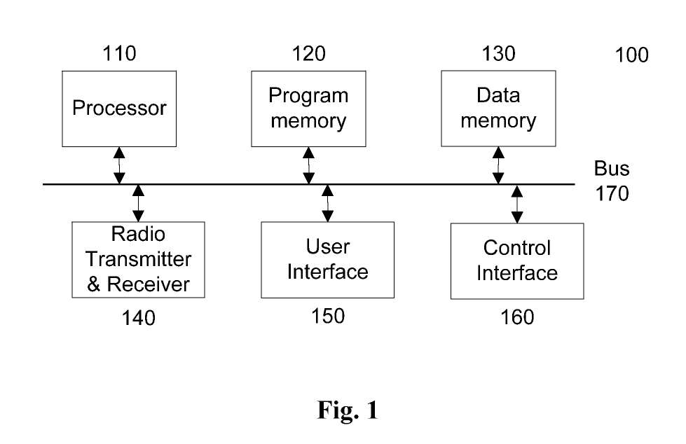

Although various embodiments are described herein above as methods, the person of ordinary skill will readily comprehend that such methods may be embodied by various combinations of hardware and software in various systems, computing devices, control devices, apparatuses, non-transitory computer-readable media, etc. FIG. 1 shows a block diagram of an exemplary device or apparatus utilizing certain embodiments of the present disclosure, including execution of instructions on the computer-readable medium comprising combinatorial optimization using event-driven, Lagrangian branch-and-bound techniques according to one or more of the embodiments described herein above. Exemplary device 100 can comprise a processor 110 that can be operably connected to a program memory 120 and/or a data memory 130 via a bus 170 that may comprise parallel address and data buses, serial ports, or other methods and/or structures known to those of ordinary skill in the art. Program memory 120 comprises software code or program executed by processor 110 that facilitates, causes and/or programs exemplary device 100 to communicate using one or more wired or wireless communication protocols, including one or more wireless communication protocols standardized by 3GPP, 3GPP2, or IEEE, such as those commonly known as LTE, UMTS, HSPA, GSM, GPRS, EDGE, 1xRTT, CDMA2000, 802.11, WiFi, HDMI, USB, Firewire, etc., or any other protocols utilized in conjunction with radio transceiver 140, user interface 150, and/or host interface 160.

Program memory 120 can also comprises software code executed by processor 110 to control the functions of device 100, including configuring and controlling various components such as radio transceiver 140, user interface 150, and/or host interface 160. Program memory 120 may also comprise an application program for combinatorial optimization using event-driven, Lagrangian branch-and-bound techniques according to one or more of the embodiments described herein above. Such software code may be specified or written using any known or future developed programming language, such as e.g. Java, C++, C, Objective C, HTML, XHTML, and Assembler, as long as the desired functionality, e.g., as defined by the implemented method steps, is preserved. In addition or alternately, program memory 120 may comprise an external storage arrangement (not shown) remote from device 100, from which the instructions can be downloaded into program memory 120 located within or removably coupled to device 100, so as to enable execution of such instructions.

Data memory 130 may comprise memory area for processor 110 to store variables used in protocols, configuration, control, and other functions of device 100, including combinatorial optimization using event-driven, Lagrangian branch-and-bound techniques according to one or more of the embodiments described herein above. Moreover, program memory 120 and/or data memory 130 may comprise non-volatile memory (e.g., flash memory), volatile memory (e.g., static or dynamic RAM), or a combination thereof. Furthermore, data memory 130 may comprise a memory slot by which removable memory cards in one or more formats (e.g., SD Card, Memory Stick, Compact Flash, etc.) may be inserted and removed. Persons of ordinary skill in the art will recognize that processor 110 may comprise multiple individual processors (e.g., multi-core processors), each of which implements a portion of the functionality described above. In such case, multiple individual processors may be commonly connected to program memory 120 and data memory 130 or individually connected to multiple individual program memories and or data memories. More generally, persons of ordinary skill in the art will recognize that various protocols and other functions of device 100 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 140 may comprise radio-frequency transmitter and/or receiver functionality that enables device 100 to communicate with other equipment supporting like wireless communication standards. In an exemplary embodiment, radio transceiver 140 includes an LTE transmitter and receiver that enable device 100 to communicate with various Long Term Evolution (LTE) networks (also known as “4G”) according to standards promulgated by 3GPP. In some exemplary embodiments of the present disclosure, radio transceiver 140 includes circuitry, firmware, etc. necessary for device 100 to communicate with various UMTS and/or GSM/EDGE networks, also according to 3GPP standards. In some exemplary embodiments of the present disclosure, radio transceiver 140 includes circuitry, firmware, etc. necessary for device 100 to communicate with various CDMA2000 networks, according to 3GPP2 standards. In some exemplary embodiments of the present disclosure, radio transceiver 140 is capable of communicating using radio technologies that operate in unlicensed frequency bands, such as IEEE 802.11 WiFi that operates using frequencies in the regions of 2.4 and/or 5.6 GHz. In some exemplary embodiments of the present disclosure, radio transceiver 140 may comprise a transceiver that is capable of wired communication, such as by using IEEE 802.3 Ethernet technology. The functionality particular to each of these embodiments may be coupled with or controlled by other circuitry in device 100, such as processor 110 executing protocol program code stored in program memory 120.

User interface 150 may take various forms depending on the particular embodiment of device 100. In some exemplary embodiments of the present disclosure, user interface 150 may comprise a microphone, a loudspeaker, slidable buttons, depressable buttons, a display, a touchscreen display, a mechanical or virtual keypad, a mechanical or virtual keyboard, and/or any other user-interface features commonly found on mobile phones. In other embodiments, device 100 may comprise a tablet computing device (such as an iPad® sold by Apple, Inc.) including a larger touchscreen display. In such embodiments, one or more of the mechanical features of user interface 150 may be replaced by comparable or functionally equivalent virtual user interface features (e.g., virtual keypad, virtual buttons, etc.) implemented using the touchscreen display, as familiar to persons of ordinary skill in the art. In other embodiments, device 100 may be a digital computing device, such as a laptop computer, desktop computer, workstation, etc. that comprises a mechanical keyboard that may be integrated, detached, or detachable depending on the particular embodiment. Such a digital computing device may also comprise a touch screen display. Many exemplary embodiments of device 100 having a touch screen display are capable of receiving user inputs, including inputs related to computing a solution to one or more combinatorial optimization problems found in one or more applications described herein or known to persons of ordinary skill in the art.

In some exemplary embodiments of the present disclosure, device 100 may comprise an orientation sensor, which can be used to sense when the user has changed the physical orientation of the device 100's touch screen display. An indication signal from the orientation sensor may be available to any application program executing on device 100, such that an application program may change the orientation of a screen display (e.g., from portrait to landscape) automatically when the indication signal indicates an approximate 90-degree change in physical orientation of the device. In this manner, the application program can maintain the screen display in a manner that is readable by the user, regardless of the physical orientation of the device.

Control interface 160 of device 100 may take various forms depending on the particular embodiment of device 100 and of the particular interface requirements of the hardware under control of device 100. For example, control interface 160 may comprise an RS-232 interface, an RS-485 interface, a USB interface, an HDMI interface, a Bluetooth interface, or the like. In some exemplary embodiments of the present disclosure, control interface 160 may comprise an IEEE 802.3 Ethernet interface such as described above. In some exemplary embodiments of the present disclosure, control interface 160 may comprise analog interface circuitry including, for example, one or more digital-to-analog (D/A) and/or analog-to-digital (A/D) converters.

Persons of ordinary skill in the art will recognize the above list of features, interfaces, and radio-frequency communication standards is merely exemplary and not limiting to the scope of the present disclosure. In other words, device 100 may comprise more functionality than is shown in FIG. 1 including, for example, a video and/or still-image camera, microphone, media player, etc. Moreover, radio transceiver 140 may include circuitry necessary to communicate using additional radio-frequency communication standards including Bluetooth, GPS, and/or others. Accordingly, processor 110 may execute software code stored in program memory 120 to control such additional functionality.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. A device or apparatus may be regarded as a device or apparatus, or as an assembly of multiple devices and/or apparatuses, whether functionally in cooperation with or independently of each other. Moreover, devices and apparatuses may be implemented in a distributed fashion throughout a system, so long as the functionality of the device or apparatus is preserved. Such and similar principles are considered as known to a skilled person.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A computer-implemented method for selecting a particular alternative, from among a discrete set of alternatives, that is preferable with respect to one or more objectives, comprising:
determining a Lagrangian function of the alternatives and at least one parameter;
selecting an initial alternative from among the discrete set;
determining values for the at least one parameter; and
selecting, via one or more iterations, the particular alternative in the discrete set that reduces the Lagrangian function subject to the determined values for the at least one parameter.

2. The computer-implemented method of claim 1, wherein:
the one or more objectives comprise an additive function of individual objectives;
the Lagrangian function further comprises one or more constraints on the selection of a particular alternative; and
each of the one or more constraints comprise one or more additive functions of individual constraints.

3. The computer-implemented method of claim 1, wherein selecting the particular alternative further comprises:
determining at least two alternatives for which selection of a first of the at least two alternatives results in a preference for a second of the at least two alternatives;
dividing the discrete set into a plurality of disjoint sets of approximately equal size, including a first set comprising the first of the at least two alternatives and a second set comprising the second of the at least two alternatives;
maintaining solution branches for each of the plurality of sets during the one or more iterations, comprising eliminating solution branches that are determined to be unfeasible; and
selecting the alternative corresponding to a solution branch that reaches an optimal value or to a solution branch that remains after all other solution branches have been eliminated.

4. The computer-implemented method of claim 1, further comprising selecting the particular alternative in the discrete set that minimizes the Lagrangian function subject to the determined values for the at least one parameter.

5. The computer-implemented method of claim 1, wherein the initial alternative is selected arbitrarily.

6. The computer-implemented method of claim 1, wherein the discrete set of alternatives comprises at least one of an operation space of a system or a process and a design space of a system or a process.

7. The computer-implemented method of claim 6, wherein the system or process relates to at least one of manufacturing, transportation, and communications.

8. A device for selecting a particular alternative of a discrete set of alternatives that is preferable with respect to one or more objectives, comprising:
at least one processor;
a non-transitory, computer-readable medium comprising computer-executable instructions that, when executed by the at least one processor, cause the device to:
determine a Lagrangian function of the alternatives and at least one parameter;
select an initial alternative from among the discrete set;
determine values for the at least one parameter; and
select, via one or more iterations, the particular alternative in the discrete set that reduces the Lagrangian function subject to the determined values for the at least one parameter.

9. The device of claim 8, wherein:
the one or more objectives comprise an additive function of individual objectives;
the Lagrangian function further comprises one or more constraints on the selection of a particular alternative; and
each of the one or more constraints comprise one or more additive functions of individual constraints.

10. The device of claim 8, wherein the computer-executable instructions that, when executed by the at least one processor, cause the device to select the particular alternative further comprise instructions that, when executed by the at least one processor, cause the device to:
determine at least two alternatives for which selection of a first of the at least two alternatives results in a preference for a second of the at least two alternatives;
divide the discrete set into a plurality of disjoint sets of approximately equal size, including a first set comprising the first of the at least two alternatives and a second set comprising the second of the at least two alternatives;
maintain solution branches for each of the plurality of sets during the one or more iterations, comprising eliminating solution branches that are determined to be unfeasible; and
select the alternative corresponding to a solution branch that reaches an optimal value or to a solution branch that remains after all other solution branches have been eliminated.

11. The device of claim 8, wherein the computer-executable instructions that, when executed by the at least one processor, cause the device to select the particular alternative further comprise instructions that, when executed by the at least one processor, cause the device to select the particular alternative that minimizes the Lagrangian function subject to the determined values for the at least one parameter.

12. The device of claim 8, wherein the computer-executable instructions that, when executed by the at least one processor, cause the device to select the initial alternative further comprise instructions that, when executed by the at least one processor, cause the device to select the initial alternative arbitrarily.

13. The device of claim 8, wherein the discrete set of alternatives comprises at least one of an operation space of a system or a process and a design space of a system or a process.

14. The device of claim 13, wherein the system or process relates to at least one of manufacturing, transportation, and communications.

15. A non-transitory, computer-readable medium for selecting a particular alternative from a discrete set of alternatives that is preferable with respect to one or more objectives, the medium comprising computer-executable instructions that when executed by at least one processor, cause the at least one processor to:
determine a Lagrangian function of the alternatives and at least one parameter;
select an initial alternative from among the discrete set;
determine values for the at least one parameter; and
select, via one or more iterations, the alternative in the discrete set that reduces the Lagrangian function subject to the determined values for the at least one parameter.

16. The non-transitory, computer-readable medium of claim 15, wherein:
the one or more objectives comprise an additive function of individual objectives;
the Lagrangian function further comprises one or more constraints on the selection of a particular alternative; and
each of the one or more constraints comprise one or more additive functions of individual constraints.

17. The non-transitory, computer-readable medium of claim 15, wherein the computer-executable instructions that, when executed by the at least one processor, cause the at least one processor to select the particular alternative further comprise instructions that, when executed by the at least one processor, cause the at least one processor to:
determine at least two alternatives for which selection of a first of the at least two alternatives results in a preference for a second of the at least two alternatives;
divide the discrete set into a plurality of disjoint sets of approximately equal size, including a first set comprising the first of the at least two alternatives and a second set comprising the second of the at least two alternatives;
maintain solution branches for each of the plurality of sets during the one or more iterations, comprising eliminating solution branches that are determined to be unfeasible; and
select the alternative corresponding to a solution branch that reaches an optimal value or to a solution branch that remains after all other solution branches have been eliminated.

18. The non-transitory, computer-readable medium of claim 15, wherein the computer-executable instructions that, when executed by the at least one processor, cause the at least one processor to select the particular alternative further comprise instructions that, when executed by the at least one processor, cause the at least one processor to select the particular alternative that minimizes the Lagrangian function subject to the determined values for the at least one parameter.

19. The non-transitory, computer-readable medium of claim 15, wherein the computer-executable instructions that, when executed by the at least one processor, cause the at least one processor to select the initial alternative further comprise instructions that, when executed by the at least one processor, cause the at least one processor to select the initial alternative arbitrarily.

20. The non-transitory, computer-readable medium of claim 15, wherein the discrete set of alternatives comprises at least one of an operation space of a system or a process and a design space of a system or a process.

21. The non-transitory, computer-readable medium of claim 20, wherein the system or process relates to at least one of manufacturing, transportation, and communications.
